(19) United States
(12) Patent Application Publication
(10) Pub. No.: US 2010/0212016 A1
(43) Pub. Date: Aug. 19, 2010

(54) CONTENT PROTECTION INTEROPERRABILITY

(75) Inventors: Kedarnath A. Dubhashi, Redmond, WA (US); Kenneth S. Reneris, Bellevue, WA (US); John C. Simmons, North Bend, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/388,285

(22) Filed: Feb. 18, 2009

(51) Int. Cl. G06F 21/00

(52) U.S. Cl. 726/26

(57) ABSTRACT

Various embodiments provide content protection interoperability techniques which support secure distribution of content for multiple content protection technologies. In one or more embodiments a source digital rights management (DRM) system can associate trust data with content to be exported to a target digital rights management (DRM) system. The trust data describes a trust state for the content to enable the target DRM system to maintain the trust state for the exported content. In at least some embodiments, the source DRM system can also associate tracing data with the content to, in the event of a breach in the chain of trust, enable an identification to be made of a source of the exported content and/or a party responsible for exporting the content.

### BACKGROUND

Content providers demand a trustworthy framework for protected distribution of their content. In a traditional approach to protecting distributed content, each content provider selected their own, and perhaps proprietary, content protection technology. This approach resulted in multiple, incompatible content protection technologies being used to protect content. At the same time consumers continually demand an expansion of their rights associated with content. For instance, consumers may have multiple devices (computer, handheld, media-player, set-top box) on which they would like to interact with content they have legitimately obtained. However, different devices often employ different content protection technologies.

Thus, business realities demand multiple, interoperating content protection technologies in part to support an expansion of rights granted to consumers. Principally because of competing business interests of developers and manufacturers, creating an interoperability framework has proved to be challenging.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide content protection interoperability techniques which support secure distribution of content for multiple content protection technologies. In one or more embodiments, a source digital rights management (DRM) system can associate trust data with content to be exported to a target digital rights management (DRM) system. The trust data describes a trust state for the content to enable the target DRM system to maintain the trust state for the exported content. In at least some embodiments, the source DRM system can also associate tracing data with the content to, in the event of a breach in the chain of trust, enable an identification to be made of a source of the content and/or a party responsible for exporting the content.

### BRIEF DESCRIPTION OF THE DRAWINGS

FIG. 1 illustrates an operating environment in which the inventive principles can be employed in accordance with one or more embodiments.

FIG. 2 illustrates an example arrangement of a content distribution framework in which the inventive principles can be employed in accordance with one or more embodiments.

FIG. 3 is a flow diagram that describes an example procedure in accordance with one or more embodiments.

FIG. 4 is a flow diagram that describes an example procedure in accordance with one or more embodiments.

FIG. 5 is a flow diagram that describes steps in an example procedure in accordance with one or more embodiments.

FIG. 6 is a block diagram of a system that can implement the various embodiments.

### DETAILED DESCRIPTION

Overview

Various embodiments provide content protection interoperability techniques which support secure distribution of content for multiple content protection technologies. In one or more embodiments, a source digital rights management (DRM) system can associate trust data with content to be exported to a target digital rights management (DRM) system. The trust data describes a trust state for the content to enable the target DRM system to maintain the trust state for the exported content. In at least some embodiments, the source DRM system can also associate tracing data with the content to, in the event of a breach in the chain of trust, enable an identification to be made of a source of the exported content and/or a party responsible for exporting the content. Note that while various techniques for content protection interoperability are described herein in the context of a DRM system, the described techniques are also applicable within the context of a variety of other suitable systems including, but not limited to, an Advanced Access Content System (AACS) or other suitable copy protection system and/or content protection technologies generally.

In the discussion that follows, a section entitled “Operating Environment” describes but one environment in which the various embodiments can be employed. Following this, a section entitled “Content Distribution Framework Examples” describes example components and techniques for distributing in accordance with one or more embodiments. After that, a section entitled “Example Content Protection Interoperability Procedures” describes example procedures in accordance with one or more embodiments. Last, a section entitled “Example System” is provided and describes an example system that can be used to implement one or more embodiments.

Operating Environment

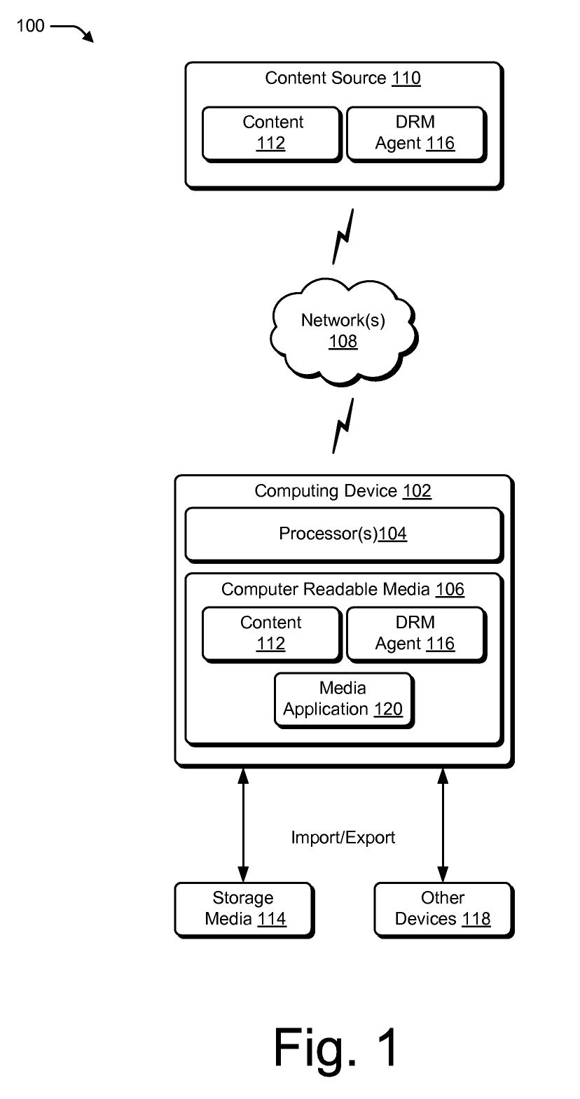

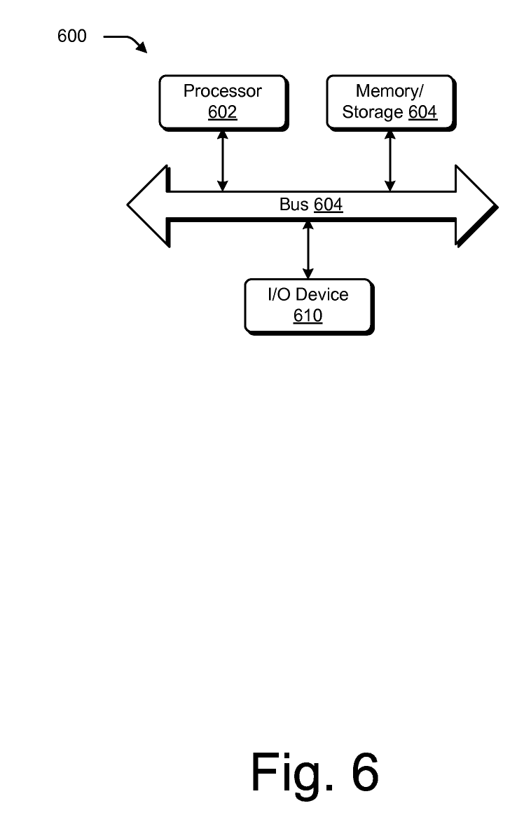

FIG. 1 illustrates an operating environment in accordance with one or more embodiments, generally at 100. In at least some embodiments, the environment 100 may be configured for protected content distribution. Environment 100 includes a computing device 102 having one or more processors 104, and one or more computer-readable media 106. The computer-readable media 106 can include, by way of example and not limitation, all forms of volatile and non-volatile memory and/or storage media that are typically associated with a computing device. Such media can include ROM, RAM, flash memory, a hard disk, optical discs, removable storage media, and the like. One specific example of a computing device is shown and described below in relation to FIG. 6. Further, computing device 102 can be embodied as any suitable computing device such as, by way of example and not limitation, a desktop computer, a set-top box, a portable computer, a DVR, a DVD player, a server, a handheld computer such as a personal digital assistant (PDA) or portable media player, a cell phone, and the like.

Computing device 102 may be connected by way of one or more networks 108 to one or more content sources 110. Content sources 110 can be configured to distribute various content 112 to the computing device 102. Examples of content include movies, streaming video, video-on-demand (VOD), audio files, television broadcasts, web-based content and services, and images, to name a few. Distribution of content 112 can occur in any suitable manner. By way of example and not limitation, content 112 can be communicated over one or more networks 108 to be received by the computing device 102. Additionally or alternatively, content can be distributed by way of storage media 114, as depicted in FIG. 1. Storage media 114 represents portable/removable forms of computer-readable storage media that can be configured to store various data including content 112 from one or more content sources. Computing device 102 can be configured to interact with content stored on various forms of storage media, such as optical disks, flash memory devices, and portable hard drives, to name a few.

To facilitate digital right managements (DRM) for content that is imported or exported, one or more components of the example environment can include or otherwise make use of a digital rights management (DRM) agent 116 that operates as described above and below. For example, computing device 102 and content source 110 are each illustrated as having a respective DRM agent 116. The DRM agent represents a variety of functionality operable to establish and enforce digital rights associated with distribution of content 112. For example, a DRM agent at a computing device can process content imported from content sources to maintain digital rights associated with the content. This can include maintaining of a trust state associated with the imported content by a DRM agent deployed at the source of the content.

The DRM agent also enables export of content to other devices 118, such as exporting content from a set-top box to a portable media device. DRM agent may be provided with each device (e.g., each content source 110, computing device 102, and/or other device 118) to enable interaction with the content at the device based upon whether content is trusted or not. Moreover, the DRM agent operates with various content protection technologies. To do so, the DRM agent enables transfer of a trust state between DRM systems that can employ different content protection technologies. In this way, the DRM agent facilitates interoperability of the different content protection technologies.

Environment 100 is also depicted as including a media application 120 that resides on the computer-readable media and is executable by the processor(s). The media application 120 represents functionality operable to provide various interaction with content at the computing device. Media application 120 can enable playback of content, viewing of images, recording of content (e.g., digital video recorder (DVR) functions), transfer of content to and from various storage media (e.g., “burning” of content to optical discs or other portable/removable storage), synchronization of content between the computing device and other devices 118, playlist creation and management, and so forth. Media application 120 can also incorporate or otherwise make use of communication functionality (e.g., a browser) to search for and obtain content, download content for streaming playback and/or recording, and/or retrieve and update supplemental information and metadata associated with content. Examples of supplemental information and metadata that can be associated with content include titles, artist or actor data, track or chapter names, and artwork, to name a few. In at least some embodiments, a DRM agent 116 may be implemented as a component of the media application 120.

Various other applications (not shown) can reside on the computer-readable media which are executable by the processor(s) to provide a wide range of functionality to the computing device 102. Applications can include any suitable type of application, including but not limited to applications for office productivity, email, media management, printing, networking, web-browsing, an electronic program guide (EPG), and a variety of other applications.

Having considered an example operating environment, consider now content distribution framework examples in accordance with one or more embodiments.

Content Distribution Framework Examples

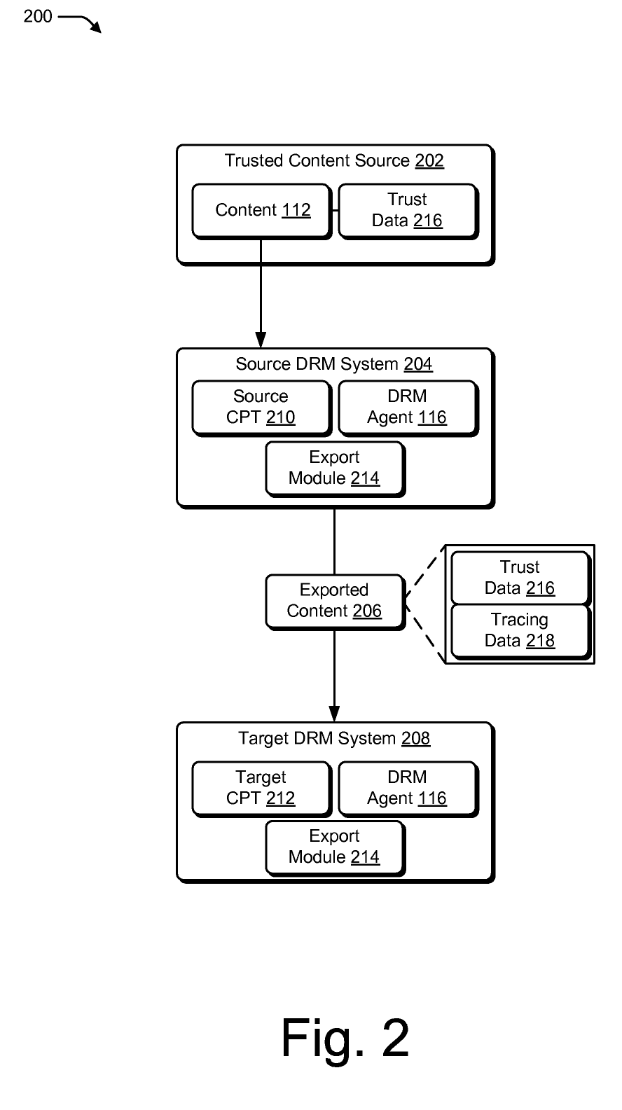

FIG. 2 illustrates an example arrangement 200 of a content distribution framework in which the inventive principles can be employed in accordance with one or more embodiments.

Specifically, FIG. 2 depicts an example content distribution framework in which various components can make use of a DRM agent 116 to implement interoperability for multiple content protection technologies (CPTs). By doing so, content can be securely and efficiently distributed between source and target DRM systems while supporting the multiple content protection technologies.

The example of FIG. 2 illustrates protected export of content 112 that can be obtained from a trusted content source 202 by a source DRM system 204. Examples of trusted content sources 202 include IPTV, cable television, and content sources that operate in compliance with a trusted content protection technology (CPT), such as Advanced Access Content System (AACS). Of course in some instances, content may be obtained from content sources that are un-trusted, such as from analog inputs, unprotected Internet videos, and consumer created content (e.g., home movies). It just so happens that in this example, the depicted content source is trusted.

Source digital rights management (DRM) system 204 may obtain the content from the trusted content source 202. This may occur over a network, by way of storage media, or by another suitable distribution mechanism. The source DRM system can create exported content 206 for distribution to a target DRM system 208. Note that the source and target DRM systems are associated with a source content protection technology (CPT) 210 and a target content protection technology (CPT) 212, respectively. Source CPT 210 and target CPT 212 may represent different technologies that are employed by different DRM systems. Of course, in some instances, source CPT 210 and target CPT 212 may be configured as the same technology. Examples of content protection technologies include, but are not limited to, Content Scramble System (CSS), Advanced Access Content System (AACS), PlayReady, OMA, Marlin, and Digital Transmission Content Protection (DTCP), to name a few.

Each of the source DRM system and target DRM system is also depicted as including an export module 214. Although illustrated as a standalone module, in at least some embodiments the export module 214 can be implemented as a component of the DRM agent 116. The export module 214 represents functionality of a DRM system that is operable to perform actions related to exporting content in accordance with content protection interoperability techniques described herein. Such actions can include, but are not limited, receiving and processing export requests, preparing content for export, and associating content with data to define a trust state, to name a few

For instance, the DRM agent 116 and/or export module 214 deployed to the source DRM system can interact to implement techniques for content protection interoperability described above and below. One way this can occur is by association of trust data 216 with content that is obtained from a content source. For instance, the DRM agent can make use of the export module 214 or equivalent functionality to create exported content and associate the content with trust data 216. The trust data can then be exported along with exported content. Trust data may be generated at various times, such as when content is obtained, when interaction with content occurs at the source DRM system, and/or when content is exported to storage media and/or a target DRM system.

Trust data 216 can be configured to describe a trust state associated with the content by a content source and/or the source DRM system. The trust data 216 can be configured to reflect a trust state that is associated with content when the content is created. For example, as depicted in FIG. 2, trusted content source 202 can configure trust data 216 to associate a trust state with content when the content is created. This trust state can be extracted from the trust data by a system receiving the content and can be preserved through the chain of distribution of the content. Accordingly, the trust state may be configured to indicate whether the content is trusted or un-trusted by the content source and/or the source DRM system. The trust data 216 enables transfer of the trust state from the source CPT 210 to target CPT 212. Note that transfer of a trust state using trust data 216 can occur in instances where content protection technologies are the same, as well as in instances where content protection technologies are different.

Computing devices that are compliant with content protection interoperability techniques described herein can be configured to take measures to prevent playback of and/or other interaction with content that is un-trusted. These measures can be taken based in part upon trust data 216 that is associated with the content. In at least some embodiments, a device may be configured to search for a digital watermark when content is considered un-trusted. If the watermark is discovered, then the device can restrict playback of the content. On the other hand, when the content is considered trusted, the device may forego searching for the watermark and permit interaction with the content, e.g., playback, recording, and so forth.

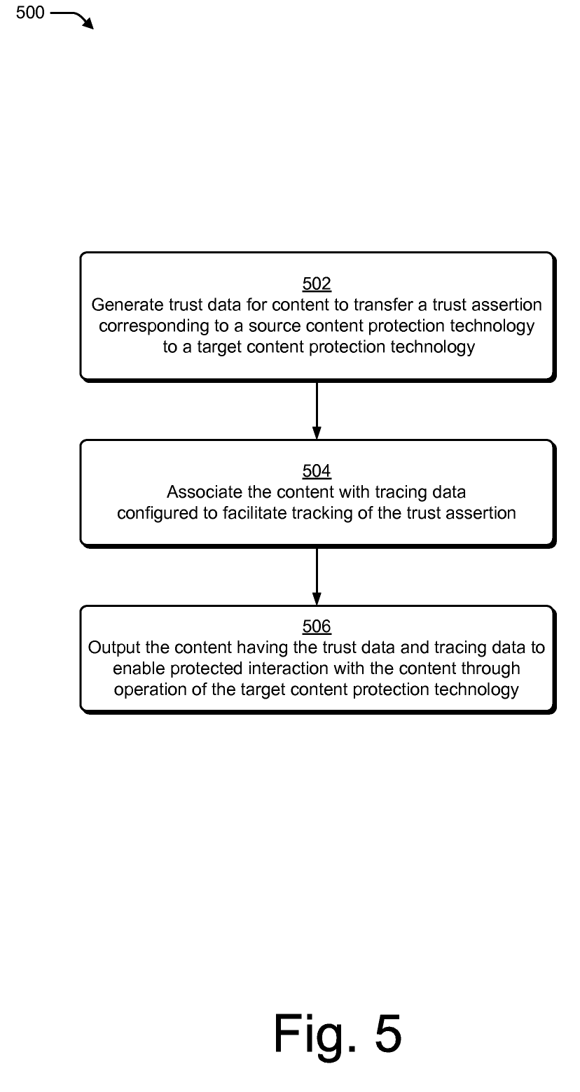

DRM agent 116 can also operate to associate tracing data 218 with exported content 208. The tracing data 218 is configured to facilitate tracking of content in the event of a trust breach. A trust breach can occur in various ways. In general, a trust breach can occur through actions that are considered non-compliant for the content distribution framework and compliant devices. For instance, content that is marked as un-trusted can be “laundered” by marking the content as trusted. Trusted content can be “soiled” by removal of protection measures associated with the trusted content or transfer of the content to a non-compliant protection technology. Upon discovering laundered content, soiled content, or other trust breaches, tracing data 218 can be employed to track the content back along a chain of distribution. This back tracking using the tracing data can facilitate identification of potential sources of the breach and/or responsible parties. Additional discussion regarding tracing data 218 configured to facilitate responses to trust a breach is provided in relation to FIG. 5 below.

Having considered an example framework in which content protection interoperability techniques may be employed, consider now a discussion of example procedures that may implemented within the example framework and/or in other suitable content distribution environments.

Example Content Protection Interoperability Procedures

The following discussion describes techniques related to content protection interoperability that may be implemented utilizing the previously described environment, framework, systems, and/or devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the example environment 100 of FIG. 1 and the example framework 200 of FIG. 2.

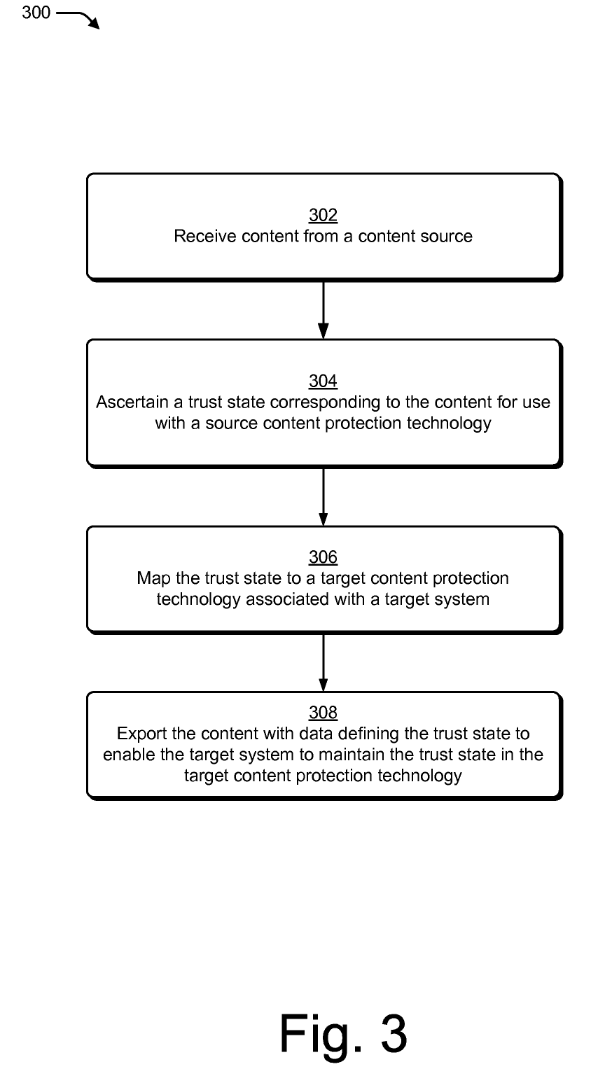

FIG. 3 is a flow diagram that describes an example procedure 300 in accordance with one or more embodiments. In at least some embodiments, the procedure 300 can be performed by a suitably configured DRM agent, such as to transfer a trust state associated with content that is exported to another device or system.

Step 302 receives content from a content source. One way in which content can be received is through operation of a media application 120 of a computing device 102. Media application 120 can be executed to navigate over one more networks and to enable selections of content available from various content sources. Content can also be received at a computing device by way of various storage media. A DRM agent 116 may operate in conjunction with the media application to manage and enforce digital rights associated with the content.

Step 304 ascertains a trust state corresponding to the received content for use with a source content protection technology. One way this can occur is through association of trust data 216 with the content. For example, trust data may be associated by a content source with content that is distributed for receipt by a source DRM system that makes use of a source content protection technology. Accordingly, the source DRM system can ascertain the trust state from the trust data. As noted, the trust data 216 is configured to define a trust state for the content with respect to the source content protection technology. The trust state can be configured to mark the content as being either trusted or un-trusted. This marking of content with trust data designates the trust state for the content at the source system and for use by the source CPT.

Step 306 maps the trust state to a target content protection technology associated with a target system. This step can occur in the course of preparing content for export. For example, a DRM agent can perform mapping in response to an export request, as content is being burned to an optical disk, or otherwise in the course of preparing content for export. To do so, DRM agent can incorporate or otherwise make use of an export module configured to perform various actions related to exporting content. Mapping the trust state can involve determining one or more target DRM systems to receive the content and configuring trust data in a format that is understandable by the CPTs associated with the target DRM systems. In this way, trust data defining the trust state can be translated from one CPT to a format that is compatible with another CPT. The trust data can then be encoded onto the optical disk and/or packaged with the content for export over a network. DRM agents deployed to other devices can then make use of the trust data to maintain a trust state associated with content for content protection technologies employed by the devices.

In at least some embodiments, the trust data can be configured at least set a trust state, associate the trust state with the content, and provide a mechanism to securely transfer the trust state between content protection technologies. The trust state can be set in any suitable way. For example, the trust state may be set by way of a trusted bit, a Boolean value, a flag, a yes/no data field, or other suitable data to make an assertion as to whether particular content is trusted or un-trusted. In one particular example, a trusted bit can employed that indicates trusted content when set to a value of one, and indicates un-trusted content when set to or left as a value of zero. A variety of other techniques to set a trust state are also contemplated.

The data configured to make the trust assertion can then be associated with corresponding content in a variety of ways. In one approach, the trust data includes information suitable to identify particular content. Any suitable content identification mechanism can be employed. By way of example and not limitation, identification may occur by way of an unique content ID, a hash of the content or a portion of the content, and/or a content digest, to name a few. In another example, trust data can be embedded into, appended to, or otherwise linked directly to corresponding content. For example, trust data can be configured as metadata that is transferred along with the content.

To securely transfer the trust state, the trust data can itself be protected. For instance, a trusted bit (or other trust assertion) can be packaged along with content identifying information, signed using a digital certificate. In the absence of a signature, content can be considered un-trusted.

A variety of cryptographic techniques can be employed to digitally sign and verify the trust data. In one example, public key infrastructure (PKI) techniques may be employed. Generally, trusted issuers are issued a certificate by a licensing authority. The issued certificate can be chained to a trusted root certificate. In other words, the certificate can be traced to a root key that is implicitly trusted. A set of root certificates (e.g., implicitly trusted certificates) can be installed on a computing device, such as when initially the computing device is configured or when operating system software is installed. A computing device receiving the digitally signed information can execute a DRM agent to check the certificate used to sign the information against a root certificate to determine whether to trust the information. By doing so, the DRM agent verifies that the signer is who they claim to be.

Step 308 exports the content having the trust data to enable the target system to maintain the trust state in the target content protection technology. For instance, a DRM agent can operate to ensure that trust data is exported with associated content. For example, a source DRM system 204 as depicted in FIG. 2 can mark and map content 112 using a DRM agent 116 for export to target DRM system 208 as just described. The source DRM system can export the content along with digitally signed trust data 216 corresponding to the content. By way of a DRM agent 116 that is deployed to the target system, the trust data can be utilized with a target content protection technology 212. In particular, the trust data can be used to determine a trust state associated with the content. This enables the trust state to be maintained across different content protection technologies.

Note that marking of content to define a trust state can be considered an assertion of trust by the source DRM system with respect to the content. So long as the source DRM system is trusted and a trust breach has not occurred, the trust assertion can be relied upon by other devices and systems that receive content exported by the source DRM system. Such devices and systems can take actions to enable or restrict interaction with the content based at least in part upon the trust data, further discussion of which may be found in relation to the following procedure.

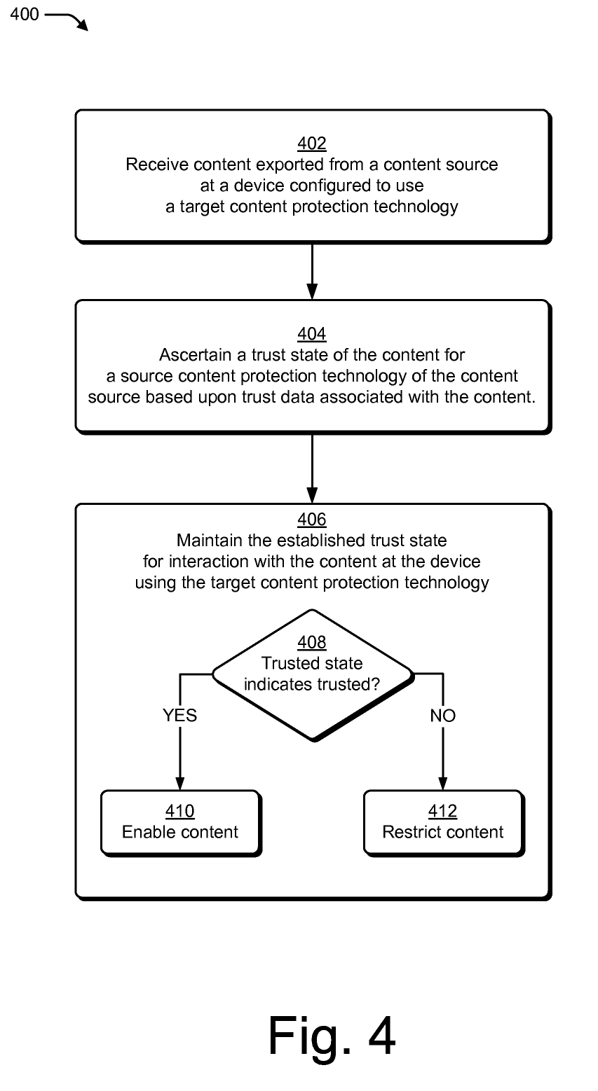

FIG. 4 is a flow diagram that describes an example procedure 400 in accordance with one or more embodiments. In at least some embodiments, the procedure can be performed by a suitably configured DRM agent, such as to provide protected access at a computing device to content that is exported from another device or system.

Step 402 receives content exported from a content source at a device configured to use a target content protection technology. For example, a target DRM system 208 may receive exported content 206 from a source DRM system 204 as depicted in FIG. 2. For example, content can be exported by “burning” the content to storage media, such as a DVD or Blu-Ray disc. This enables transfer of the content from one device to another device. A target DRM system can receive the exported content by way of such storage media. A target DRM system can also receive exported content that is communicated over a network. For example, content can be broadcast or streamed to the target DRM system via the Internet to enable immediate playback (e.g., substantially in real-time) and/or recording of the content. Still further, content can be received by way of a local connection, such as via a serial connection or a USB connection.

Step 404 ascertains a trust state of the content for a source content protection technology of the content source based upon trust data associated with the content. A trust state for content can be ascertained in any suitable way. For example, a target DRM system 208 can make use of trust data 216 associated with content to ascertain a corresponding trust state. In at least some embodiments, a source DRM system can include trust data 216 that is mapped to a target CPT associated with the target DRM system when exporting the content. Additionally or alternatively, mapping of trust data to the target CPT can occur by way of a DRM agent that is deployed to the target system. In either case, the target system can obtain trust data that is configured in a format that is understandable by the target CPT.

The trust data obtained from a source system may be digitally signed using a certificate. The DRM agent can then check the validity of the certificate by chaining to a trusted root certificate. This can be done to ensure that the exporter of the content (e.g., the source system) is trusted. When the certificate is invalid, then the DRM agent can determine that the source is un-trusted, and accordingly can establish the trust state for the content as un-trusted. When the certificate is valid, the DRM agent can rely upon the corresponding trust data to establish trust. For instance, the DRM agent can extract and process the trust data to establish a trust state for the received content according to the trust data.

When the trust state has been established, step 406 maintains the established trust state for interaction with the content at the device using the target content protection technology. This step can involve providing protected access to the content based upon the established trust state. To do so, step 408 makes a determination as to whether the trust state indicates that the content is trusted or un-trusted. The DRM agent may rely upon trust data associated with content to retrieve the corresponding trust state. For example, if the trust state is set using a trusted bit, the DRM agent can determine whether the trusted bit is set to zero or one.

The DRM agent can also reference content identifying information included with the trust data to verify that the trust data is correctly matched to the content. For example, the DRM agent can generate a hash of the content and compare the hash value to a hash value that is included with the trust data to ensure that the values match. If the content is not properly identified (e.g., the hash values do not match), then the DRM agent may disregard the trust data, and accordingly can establish the trust state for the content as un-trusted.

If the content is trusted, step 410 enables interaction with the content. In this case, the DRM agent may permit interaction such as playback, recording, export, and so forth. If the content is un-trusted, step 412 restricts interaction with the content. In this case, the DRM agent can implement various restrictions with respect to the content. For instance, the DRM agent can disable playback and/or recording of content that is un-trusted. The DRM agent can also output a notification or overlay to restrict viewing of the content and/or inform a viewer regarding the un-trusted state of the content.

Consider now a few example scenarios to further illustrate aspects of content protection technology interoperability techniques described herein. The following examples are described in the context of a framework that makes use of Advanced Access Content System (AACS) technology. AACS provides a set of standards and rules for content distribution and digital rights management. In such a framework, content protection technology interoperability techniques described herein may be employed to provide AACS compliant systems, devices, and techniques. Specifically, a DRM agent that is AACS compliant may be deployed to various devices to implement AACS compliance. Compliant devices can be configured to at least record/export content in an AACS compliant format and to implement restrictions for non-compliant formats and content. This can involve associating exported content with one or more data structures configured to pass trust data 216 and/or tracing data 218 between CPTs as described herein.

In a first scenario, Hiro records a high definition movie from ISDB cable television onto his computing device. Although he is not aware of this, the movie has been embedded with a digital watermark and is AACS compliant. Hiro would like to burn this movie onto a Blu-Ray DVD for his upcoming vacation. He inserts writeable Blu-Ray media into a writable drive and successfully burns the movie into an AACS compliant format. This can occur by way of a suitably configured DRM agent deployed to Hiro's computing device. Once the Blu-Ray DVD has been burned, Hiro inserts it into an AACS compliant player and begins watching it. In this case, the source of the content was trusted. This trust state was maintained by Hiro's computing device and set appropriately (e.g., using trust data) when Hiro recorded the DVD in an AACS compliant format. Accordingly, Hiro's player “trusts” the content and does not screen for the digital watermark. He is able to watch the DVD without any warnings or overlays from his player.

In another scenario, John frequently downloads content from an online media service to his personal computer. This media download service is an AACS compliant licensee and has recently begun carrying high definition content. Unfortunately, this service has also begun pirating content and re-distributing it along with content that it has legitimately obtained. John downloads a high definition movie from the service and decides to burn it to a Blu-Ray DVD so that he can watch it in his living room. The license associated with this content, and provided by the service, grants the user the rights to export using techniques described herein. This content, however, has not been properly marked as “trusted” content. Thus, a suitably configured DRM agent at John's computing device can recognize the un-trusted state of the content. Accordingly, the DRM agent can configure trust data to indicate an un-trusted state. A media application of John's computing device can include this trust data when exporting (e.g., “burning”) the content to the Blu-Ray disc. This un-trusted content also contains an embedded digital watermark.

Now, when John attempts to play the DVD, a licensed player can detect that the trust state is un-trusted. Accordingly, the player can seek and detect the digital watermark to provide protected access to the content. In response to detection of the watermark, an overlay appears on John's TV screen notifying him that the content he is watching is not valid content and John is unable to watch the DVD.

In yet another scenario, Hiro records another high definition movie from his ISDB cable connection onto his computing device. This movie contains an embedded digital watermark. Hiro will be visiting friends for the weekend and he wishes to burn this content to a DVD. He downloads DVD burning software from the Internet that allows him to burn the movie to a DVD protected with CSS. However, the downloaded burning software may not be AACS compliant. Specifically, the software does not include or make use of a suitably configured DRM agent to implement AACS compliance. As such, the DVD that Hiro burns does not include trust data that can be used to maintain a trust state across content protection technologies (CPTs). When Hiro attempts to play the DVD back in his friend's AACS licensed DVD player, the player can recognize the absence of suitable trust data and determine that the content is un-trusted. The player can output an overlay notifying Hiro that the content he is watching is not valid. By moving the content from a trusted CPT (e.g., AACS compliant PlayReady) to a non-trusted CPT (non-compliant CSS), Hiro has “soiled” the content.

Finally, consider a developer scenario in which Mary, a software developer at a software company, is writing a DVD burning application. Her application is designed to burn content recorded from cable television onto an AACS compliant recordable DVD. She designs the application to make use of a DRM agent 116 to check for both the trusted state of the content and permissions to export content in an AACS compliant format. When her application attempts to burn content that is “trusted” and which has the appropriate export rights to AACS protected DVD, it does so and produces DVDs that can be played back in AACS licensed players without issue.

FIG. 5 is a flow diagram that describes an example procedure 500 in accordance with one or more embodiments. In at least some embodiments, the procedure can be performed by a suitably configured DRM agent, such as to transfer a trust state associated with content to another device or system.

Step 502 generates trust data for content to transfer a trust assertion corresponding to a source content protection technology to a target content protection technology. For example, trust data may be generated and associated with content in accordance with procedure 300 discussed previously with respect to FIG. 3. Such trust data can be mapped to a target content protection technology through operation of a DRM agent in response to an export operation.

Step 504 associates the content with tracing data configured to facilitate tracking of the trust assertion. For instance, in response to an export operation, a DRM agent 116 can operate to associate tracing data 218 with content to be exported. The tracing data 218 is configured to facilitate tracking of content in the event of a trust breach. One example of a trust breach is when an entity uses a compromised or stolen encryption key to mark un-trusted content as trusted, e.g., “launders” the content. When the stolen key is discovered, tracing data 218 that is associated with content can assist in tracking the chain of distribution of the content and help track down parties that may be responsible for the breach.

Tracing data can be configured in any suitable way to enable tracking of the exported content along the chain of distribution. For example, tracing data may include various identifying data including, but not limited to, a licensee identifier, a public key, a digital certificate, a company name, software version/name/identifiers, and/or a time/date stamp, to name a few examples. A licensee identifier is configured to identify an entity licensed to export content in compliance with a corresponding CPT, such as AACS. In order to track the distribution chain, the tracing data associated with content by a particular exporter may also incorporate other tracing data that is passed along by one or more content sources upstream in the distribution chain. As such, the path that content took to reach a particular device or storage media can be reconstructed from the tracing data.

As with the trust data, tracing data can be digitally signed. In some embodiments, the digital signature and/or the public key can be used as identifying data to trace a discovered breach back to a source. Accordingly, upon discovering laundered content, soiled content, or other trust breaches, suitably configured tracing data can be employed to track the content back along the chain of distribution. This back tracking using the tracing data can facilitate identification of potential sources of the breach and/or responsible parties.

Step 506 outputs the content having the trust data and tracing data to enable protected interaction with content through operation of the target content protection technology. For instance, the trust data and tracing data can be burned as data structures to an optical disk (e.g., Blu-Ray Disc, DVD) or other storage media (e.g., hard disk, flash drive) along with the content. Trust data and tracing data can also be associated with content that is exported over a network, transferred to another device over a local connection, or output by any other suitable distribution technique. Note that the trust data and tracing data can be implemented as separate data structures that are individually signed. Additionally or alternatively, the trust data and tracing data can be combined into a common data structure or package that is associated with content that is output.

Having considered example procedures related content protection interoperability techniques, consider now a discussion of an example system in which can implement the content protection interoperability techniques described herein.

Example System

FIG. 6 illustrates an example computing device 600 that can implement the various embodiments described above. Computing device 600 can be, for example, computing device 102 of FIG. 1 or any other suitable computing device.

Computing device 600 includes one or more processors or processing units 602, one or more memory and/or storage components 604, one or more input/output (I/O) devices 606, and a bus 608 that allows the various components and devices to communicate with one another. Bus 608 represents one or more of any of several types of bus structures, including a memory bus or memory controller, a peripheral bus, an accelerated graphics port, and a processor or local bus using any of a variety of bus architectures. Bus 608 can include wired and/or wireless buses.

Memory/storage component 604 represents one or more computer storage media. Component 604 can include volatile media (such as random access memory (RAM)) and/or nonvolatile media (such as read only memory (ROM), Flash memory, optical disks, magnetic disks, and so forth). Component 604 can include fixed media (e.g., RAM, ROM, a fixed hard drive, etc.) as well as removable media (e.g., a Flash memory drive, a removable hard drive, an optical disk, and so forth).

One or more input/output devices 606 allow a user to enter commands and information to computing device 600, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

Software or program modules, including the DRM agent 116, media application 120, and other program modules, can be embodied as one or more instructions stored on computer-readable storage media. Such instructions may be executable by one or more articles of manufacture (for example, one or more computing device 600, and/or processors 602) to implement techniques for content protection interoperability, as well as other techniques. Such techniques include, but are not limited to, the example procedures described herein. Thus, computer-readable storage media can be configured to store instructions that when executed by one or more components of a content distribution framework or environment cause various techniques for content protection interoperability.

Computer-readable storage media includes volatile and non-volatile, removable and non-removable media implemented in any method or technology for storage of information such as computer readable instructions, data structures, program modules, or other data. Computer-readable storage media can include, but is not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or any other tangible media suitable to store the desired information and which can be accessed by a computer.

Conclusion

Various embodiments provide content protection interoperability techniques which support secure distribution of content for multiple content protection technologies. In one or more embodiments a source digital rights management (DRM) system can associate trust data with content to be exported to a target digital rights management (DRM) system. The trust data describes a trust state for the content to enable the target DRM system to maintain the trust state for the exported content. In at least some embodiments, the source DRM system can also associate tracing data with the content to, in the event of a breach in the chain of trust, enable an identification to be made of a source of the exported content and/or a party responsible for exporting the content.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-implemented method comprising:
ascertaining a trust state corresponding to content received from a content source for use with a source content protection technology;
mapping the trust state to a target content protection technology using trust data to define the trust state; and
exporting the content having the trust data to enable the trust state to be maintained in the target content protection technology.

2. The method of claim 1, wherein the ascertaining comprises determining whether the content source is trusted or un-trusted to define the trust state.

3. The method of claim 1, wherein exporting comprises communicating the content over a network to a target system that employs the target content protection technology.

4. The method of claim 1, wherein exporting comprises recording the content to storage media in a format compatible with the target content protection technology.

5. The method of claim 1, wherein mapping comprises:
determining the target content protection technology responsive to an export operation;
formatting the trust data based on the ascertained trust state corresponding to the source content protection technology in a format compatible with the target content protection technology.

6. The method of claim 1, further comprising associating the content with tracing data configured to enable identification of one or more parties in a chain of distribution corresponding to the content.

7. The method of claim 1, wherein the source content protection technology and the target content protection technology are different from one another.

8. One or more computer-readable storage media storing instructions that, when executed by a computing device, cause the computing device to:
ascertain a trust state for content received from a content source employing a source content protection technology based upon trust data associated by the content source with the content; and
maintain the established trust state for interaction with content at the computing device using a target content protection technology.

9. The computer-readable storage medium of claim 8 further storing instructions that, when executed by the computing device, cause the computing device to receive the content exported from the content source in an Advanced Access Content System (AACS) compliant format.

10. The computer-readable storage medium of claim 8, further storing instructions that, when executed by the computing device, cause the computing device to receive the trust data from the content source, the trust data being configured by the content source to transfer the trust state from the source content protection technology to the target content protection technology.

11. The computer-readable storage medium of claim 8, further storing instructions that, when executed by the computing device, cause the computing device to determine whether the trust state indicates that the content is trusted or un-trusted.

12. The computer-readable storage medium of claim 8, further storing instructions that, when executed by the computing device, cause the computing device to determine that the trust state corresponds to trusted content and enable interaction with the content at the computing device.

13. The computer-readable storage medium of claim 8, further storing instructions that, when executed by the computing device, cause the computing device to determine that the trust state corresponds to un-trusted content and restrict interaction with the content at the computing device.

14. A system comprising:
one or more processors;
one or more computer-readable storage media;
one or more program modules embodied on the one or more computer-readable storage media and configured to:
generate trust data for content to transfer a trust assertion corresponding to a source content protection technology to a target content protection technology;
associate the content with tracing data configured to facilitate tracking of the trust assertion; and
output the content having the trust data and the tracing data to enable protected interaction with the content through operation of the target content protection technology.

15. The system of claim 14, wherein the tracing data comprises a public key associated with a source of the trust assertion to enable identification of the source.

16. The system of claim 14, wherein the tracing data comprises a licensee identifier of an entity licensed to export content in an Advanced Access Content System (AACS) compliant recording format.

17. The system of claim 14, wherein at least one of the source content protection technology or the target content protection technology is Advanced Access Content System (AACS).

18. The system of claim 14, wherein to output comprises communicating the content over a network to a target computing device configured to record the content on one or more forms of computer-readable storage media.

19. The system of claim 14, wherein to output comprises burning the content to storage media.

20. The system of claim 14, wherein to output comprises streaming the content over a network to a target computing device configured to playback the content substantially in real-time.
